(19) United States
(12) Patent Application Publication
(10) Pub. No.: US 2008/0221734 A1
(43) Pub. Date: Sep. 11, 2008

(54) Categorical Color Perception System

(75) Inventors: Tomoharu Nagao, Kanagawa (JP); Noriko Yata, Kanagawa (JP); Keiji Uchikawa, Kanagawa (JP)

Correspondence Address: BIRCH STEWART KOLASCH & BIRCH, PO BOX 747, FALLS CHURCH, VA, 22040-0747, US

(73) Assignee: NATIONAL UNIVERSITY CORPORATION YOKOHAMA NATIONAL UNIVERSITY, YOKOHAMA-SHI KANAGAWA (JP)

(21) Appl. No.: 11/795,694

(22) PCT Filed: Jan. 23, 2006
(86) PCT No.: PCT/JP06/00964

§ 371 Date: Aug. 8, 2007

(30) Foreign Application Priority Data
Jan. 24, 2005 (JP) 2005-015313

(51) Int. Cl. G06N 3/08; G05B 15/02

(52) U.S. Cl. 700/259; 706/20; 901/47

(57) ABSTRACT

The present invention relates to a categorical color perception system which automatically judges a categorical color and aims to judge a categorical color name correctly under various ambient lights. Test color measured at an experiment is inputted to an input layer portion corresponding to test color components 101, illumination light components at the experiment are inputted to an input layer portion corresponding to illumination light components 102, and connection weights are obtained by learning with backpropagation method so as to output a categorical color judged by an examinee. Although a structure between the input layer portion corresponding to test color components 101 and the input-side hidden layer portion corresponding to test color components 103 and a structure between the input layer portion corresponding to illumination light components 102 and the input-side hidden layer portion corresponding to illumination light components 104 are independent, weights of structurally corresponding connections are made the same.

### TECHNICAL FIELD

The present invention relates to a categorical color perception system for automatically judging a categorical color and is pertinent to an art for correctly judging under various environments.

### BACKGROUND ART

Although we humans can distinguish subtle differences of colors, in case of telling the colors to others, we often express them in some categories as a whole such as red, blue, etc. This is called categorical perception of colors. In this way, it is also socially important to universally introduce specific color names from concrete colors for identifying things or recognizing instructions from indicators, etc.

As for the categorical perception, it is also known there are basic categorical colors that are used equally regardless of languages or persons. Through examining more than 100 kinds of languages, Berlin and Kay have shown eleven colors of white, red, green, yellow, blue, brown, orange, purple, pink, gray, and block are basic categorical colors. Further, behavioral testing of chimpanzee has also shown similar results. From these facts, it can be considered that there may be a mechanism corresponding to their color names in basic categorical colors in visual system, which is different from other color names.

On the other hand, we humans can stably perceive an inherent color of an object even if reflection spectrum from the object changes according to spectrum of ambient light. This is called color constancy.

Consequently, it can be said that which categorical color the object appears under various environments is determined not only by the reflected light spectrum of the object but also by the influence of surrounding environment and with color constancy.
Non-patent Document 1: Keisuke TAKEBE and other three persons, “Digital Color Imaging with Color Constancy,” The Transactions of Institute of Electronics, Information and Communication Engineers of Japan, The Institute of Electronics, Information and Communication Engineers, August, 2000, Vol.1, J83-D-II No. 8, pp.1753-1762.
Non-patent Document 2: Tetsuaki SUZUKI and other four persons, “Acquirement of Categorical Perceptions of Colors by a Neural Network,” ITE Technical Report, The Institute of Image Information and Television Engineers, 1999, Vol. 23, No. 29, pp.19-24.

### DISCLOSURE OF THE INVENTION

### Problems to be Solved by the Invention

Therefore, the present invention aims to provide a categorical color perception system which is capable to correctly judge a categorical color under various environments.

### Means to Solve the Problems

According to the present invention, a categorical color perception system inputting components of ambient light under a judgment environment and components of a reflected color by an object to be judged under the judgment environment and outputting a categorical color that is a categorized color name which is predicted to be perceived by an observer with the object to be judged under the judgment environment, the categorical color perception system includes:
(1) a connection weights for judgment data memory unit storing connection weights obtained by learning in a neural network for learning,

the neural network for learning has at least four layers of an input layer, an input-side hidden layer, an output-side hidden layer provided between the input-side hidden layer and an output layer, and the output layer,

the input layer comprises an input layer portion corresponding to illumination light components for inputting components of illumination light under a experimental environment and an input layer portion corresponding to test color components for inputting components of a test color that is reflected of the illumination light by a color sample,

the input-side hidden layer comprises an input-side hidden layer portion corresponding to illumination light components which is not connected to the input layer portion corresponding to test color components but connected to the input layer portion corresponding to illumination light components and an input-side hidden layer portion corresponding to test color components which is not connected to the input layer portion corresponding to illumination light components but connected to the input layer portion corresponding to test color components,

the output-side hidden layer is connected to the input-side hidden layer portion corresponding to illumination light components and the input-side hidden layer portion corresponding to test color components,

the output layer corresponds to categorical colors; and

the connection weights stored are obtained with a backpropagation method in which the neural network for learning inputs components of illumination light color for learning and components of test color for learning and output a categorical color for learning perceived by an examinee from the color sample under the illumination light; and
(2) a neural network for judgment having a same structure with the neural network for learning,

the neural network for judgment inputs the components of the ambient light of the judgment environment as the components of the illumination light color and inputs the components of the reflected color by the object to be judged under the judgment environment as the components of the test color; and

the neural network for judgment carries out a neural network operation process according to the connection weights stored in the connection weights for judgment data memory unit, and outputs the categorical color predicted to be perceived by the observer with the object to be judged under the judgment environment as a processed result.

Further, the neural network for learning and the neural network for judgment include same numbers of units for inputting color components in a same method in the input layer portion corresponding to illumination light components and the input layer portion corresponding to test color components, include same numbers of units in the input-side hidden layer portion corresponding to illumination light components and the input-side hidden layer portion corresponding to test color components, and use connection weights shared by structurally corresponding connections for connection weights with respect to connections between the input layer portion corresponding to illumination light components and the input-side hidden layer portion corresponding to illumination light components and connection weights with respect to connections between the input layer portion corresponding to test color components and the input-side hidden layer portion corresponding to test color components.

Further, a number of units of the input-side hidden layer portion corresponding to illumination light components and a number of units of the input-side hidden layer portion corresponding to test color components are at least a number of units of the input layer portion corresponding to illumination light components and a number of units of the input layer portion corresponding to test color components.

Further, the number of units of the input layer portion corresponding to illumination light components and the number of units of the input layer portion corresponding to test color components are 3, and the number of units of the input-side hidden layer portion corresponding to illumination light components and the number of units of the input-side hidden layer portion corresponding to test color components are 4.

Further, a number of units of the output-side hidden layer is at least a number of units of the input-side hidden layer portion corresponding to illumination light components and a number of units of the input-side hidden layer portion corresponding to test color components.

Further, the number of units of the output-side hidden layer is not greater than a number of units of the output layer.

Further, the number of units of the input-side hidden layer portion corresponding to illumination light components and the number of units of the input-side hidden layer portion corresponding to test color components are 4, the number of units of the output-side hidden layer is 7, and the number of units of the output layer is 11.

A robot includes:
(1) an ambient light inputting camera unit for taking ambient light in and outputting a receiving light signal of the ambient light as a first output signal;
(2) an ambient light color components sensor unit for inputting the first output signal and extracting color components of the ambient light from the first output signal;
(3) an object image taking camera unit for taking in reflected light of an object to be judged and outputting a receiving light signal of the reflected light of the object to be judged as a second output signal;
(4) an object-to-be-judged reflected color components sensor unit for inputting the second output signal and extracting color components of the reflected light from the second output signal;
(5) the categorical color perception system for inputting the color components of the ambient light and the color components of the reflected light and judging a categorical color of the object to be judged according to the color components of the ambient light and the color components of the reflected light;
(6) a robot controlling unit for inputting the categorical color and generating a control signal controlling the robot based on the categorical color; and
(7) a robot driving unit for inputting the control signal and driving an operation device according to the control signal.

A surveillance camera system includes:
(1) an ambient light inputting camera unit for taking ambient light in and outputting a receiving light signal of the ambient light as a first output signal;
(2) an ambient light color components sensor unit for inputting the first output signal and extracting color components of the ambient light from the first output signal;
(3) an object image taking camera unit for taking in reflected light of an object to be judged and outputting a receiving light signal of the reflected light of the object to be judged as a second output signal;
(4) an object-to-be-judged reflected color components sensor unit for inputting the second output signal and extracting color components of the reflected light from the second output signal;
(5) the categorical color perception system for inputting the color components of the ambient light and the color components of the reflected light and judging a categorical color of the object to be judged according to the color components of the ambient light and the color components of the reflected light; and
(6) a surveillance camera controlling unit for inputting the categorical color and generating a control signal controlling the surveillance camera system based on the categorical color.

A color coordination simulation system includes:
(1) an inputting unit for inputting specified information of ambient light;
(2) an ambient light color components generating unit for converting the specified information of the ambient light to color components of the ambient light;
(3) an object image taking camera unit for taking in reflected light of an object to be judged and outputting a receiving light signal of the reflected light of the object to be judged as an output signal;
(4) an object-to-be-judged reflected color components sensor unit for inputting the output signal and extracting color components of the reflected light from the output signal; and
(5) the categorical color perception system for inputting the color components of the ambient light and the color components of the reflected light and judging a categorical color of the object to be judged according to the color components of the ambient light and the color components of the reflected light.

A color coordination simulation system includes:
(1) an inputting unit for inputting specified information of ambient light and specified information of reflected light of an object to be judged;
(2) an ambient light color components generating unit for converting the specified information of the ambient light to color components of the ambient light;
(3) an object-to-be-judged reflected color components generating unit for converting the specified information of the reflected light of the object to be judged to color components of the reflected light; and
(4) the categorical color perception system for inputting the color components of the ambient light and the color components of the reflected light and judging a categorical color of the object to be judged according to the color components of the ambient light and the color components of the reflected light.

### Effect of the Invention

In a structure of a neural network, a portion corresponding to illumination light components and a portion corresponding to test color components are provided independently, and further connection weights of them are shared, so that a signal processing in the visual system by an input-side hidden layer portion corresponding to illumination light components becomes equivalent to a signal processing in the visual system by an input-side hidden layer portion corresponding to test color components, which unites perceptual significance of a group of signals caused by sample light and a group of signals caused by illumination light, and functionally accomplishes correction of irradiation light in higher dimensional perception. Because of this, basic categorical colors can be correctly judged under various environments.

### Preferred Embodiments for Carrying out the Invention

### Embodiment 1

First, a structure of neural network will be explained. FIG. 1 shows a structure of a layered neural network which has been used for learning. As shown in the figure, this is a feed-forward neural network having four layers (an input layer, an input-side hidden layer, an output-side hidden layer, and an output layer).

The input layer includes an input layer portion corresponding to test color components 101 and an input layer portion corresponding to illumination light components 102. The both parts include three units corresponding to three types of cones (L,M,S). Then, to each unit of the input layer portion corresponding to test color components 101, a cone response value corresponding to reflected light (test color) obtained by lighting illumination light to a color sample is inputted. To each unit of the input layer portion corresponding to illumination light components 102, a cone response value corresponding to the illumination light is inputted.

Further, the input-side hidden layer includes an input-side hidden layer portion corresponding to test color components 103 and an input-side hidden layer portion corresponding to illumination light components 104. The input-side hidden layer portion corresponding to test color components 103 and the input-side hidden layer portion corresponding to illumination light components 104 have the same number of multiple units. In this example, each has four units. Then, the input-side hidden layer portion corresponding to test color components 103 is fully connected to the input layer portion corresponding to test color components 101. Namely, each unit included in the input layer portion corresponding to test color components 101 is connected to every unit included in the input-side hidden layer portion corresponding to test color components 103. Further, the input-side hidden layer portion corresponding to illumination light components 104 is fully connected to the input layer portion corresponding to illumination light components 102. Namely, each unit included in the input layer portion corresponding to illumination light components 102 is connected to every unit included in the input-side hidden layer portion corresponding to illumination light components 104.

The output-side hidden layer includes multiple units. In this example, seven units are included. The output-side hidden layer and the input-side hidden layer (the input-side hidden layer portion corresponding to test color components 103 and the input-side hidden layer portion corresponding to illumination light components 104) are fully connected. Namely, each unit included in the input-side hidden layer is connected to every unit included in the output side hidden layer.

The output layer includes multiple units. In this example, eleven units are included. The eleven units correspond to eleven basic categorical colors, respectively. Further, the output layer is fully connected to the output-side hidden layer. Namely, each unit included in the output-side hidden layer is connected to every unit included in the output layer.

As described above, in the input layer and the input-side hidden layer, the portion corresponding to test color components and the portion corresponding to illumination light components are separated and not connected mutually. They are independent from each other. Consequently, in the input-side hidden layer, a group of signals caused by only the test color components and a group of signals caused by only the illumination light components are transmitted separately. And then, correction to the test color by the illumination light is carried out in the output-side hidden layer.

Further, the portion corresponding to test color components and the portion corresponding to illumination light components share connection weights. Between structurally corresponding connections, common connection weights are stored and commonly used by a process for the test color components and a process for the illumination light components. An L unit, an M unit, and an S unit of the input layer portion corresponding to test color components 101 structurally correspond to an L unit, an M unit, and an S unit of the input layer portion corresponding to illumination light components 102, respectively. Further, an “a” unit, a “b” unit, a “c” unit, and a “d” unit of the input-side hidden layer portion corresponding to test color components 103 structurally correspond to an “e” unit, an “f” unit, a “g” unit, and an “h” unit of the input-side hidden layer portion corresponding to illumination light components 104, respectively. Accordingly, for example, a connection between the L unit of the input layer portion corresponding to test color components 101 and the “a” unit of the input-side hidden layer portion corresponding to test color components 103 structurally corresponds to a connection between the L unit of the input layer portion corresponding to illumination light components 102 and the “e” unit of the input-side hidden layer portion corresponding to illumination light components 104, and they use one common connection weight memory area as connection weight data of the both connections. In case of reading a connection weight related to a connection between the L unit of the input layer portion corresponding to test color components 101 and the “a” unit of the input-side hidden layer portion corresponding to test color components 103, and a connection weight related to a connection between the L unit of the input layer portion corresponding to illumination light components 102 and the “e” unit of the input-side hidden layer portion corresponding to illumination light components 104, it is structured so as to read and use data of the connection weight from the common connection weight memory area. Further, in case of correcting a connection weight related to a connection between the L unit of the input layer portion corresponding to test color components 101 and the “a” unit of the input-side hidden layer portion corresponding to test color components 103, and a connection weight related to a connection between the L unit of the input layer portion corresponding to illumination light components 102 and the “e” unit of the input-side hidden layer portion corresponding to illumination light components 104, it is structured so as to read data of the connection weight from the common connection weight memory area, add/subtract correction amount to/from the data, and write the data back in the same common connection weight memory area.

Here, sigmoid function is used for input/output function of each unit of the input-side hidden layer, the output-side hidden layer, and the output layer.

Learning data which has been used for learning by the neural network will be explained. A training data set used in the embodiment is prepared by a psychophysical experiment by which categorical color perception is measured under three types of illumination lights. This experiment is carried out by displaying 424 OSA color chips (an example of color samples) one by one on a board of N5 (in Munsell color system) gray under illumination light by an LCD projector from the ceiling. FIG. 2 shows correlated color temperature and CIE (1931) xy chromaticity of the three types of the illumination lights used for this experiment. Further, FIG. 3 shows spectral distribution of these illumination lights.

Appearance of a color of displayed stimulus is measured by a categorical color naming method. According to this method, among eleven basic categorical colors, one color name which represents best the appearance of the color chip under the illumination light is answered. Examinees are four, two sessions are done with the same illumination light, assuming that naming 424 color chips is set as one session, and then 3 illumination lights×2 times=6 sessions are done. Accordingly, training data of 3 illumination lights×424=1272 sets are prepared.

Each of the test color components of the input data of the training data set is converted from luminance Lum and CIE (1931) xy chromaticity coordinate (x, y) of the OSA color chip measured under each of the illumination lights. First, conversion into values (X, Y, Z) of an XYZ color system is done according to the following expressions:

X=(x/y)×Lum

Y=Lum

Z=((1−x−y)/y)×Lum

Then, the obtained (X, Y, Z) are converted to L, M, S cone response values using Smith-Pokorny cone spectral sensitivity function. The illumination light components of the input data of the training data set are similarly converted from the measured value Lum and (x, y) of the illumination light to (L, M, S) cone response values. The obtained (L, M, S) are used for input data by normalizing between [0, 1].

For training data for outputs, real numbers are used, which are obtained by normalizing to [0, 1] a color name using rate which shows how many times a certain basic color name is used for appearance of a certain color chip out of answers of 4 persons×2 sessions=8 times obtained as a result of the experiment.

Next, a learning method will be explained. Using the training data set generated as discussed above, the above learning of the neural network is done. A modified moment method of backpropagation method is used for learning. By making the network learn such a training data, the neural network learns a mapping performed by a human brain from the LMS cones response to the names of basic categorical colors as a computation task.

In the present invention, as discussed above, learning of the connection between the input layer and the input-side hidden layer is done by using the connection weights shared between the structurally corresponding connections of the portion corresponding to test color components and the portion corresponding to illumination light components. As a result, a network is formed in which the connection weights are the same in the portion corresponding to test color components and in the portion corresponding to illumination light color components between the input layer and the input-side hidden layer.

The learning result will be explained. In order to confirm that the learning has been done correctly, the same input values as ones of the learning data set are inputted to the obtained neural network and the output is checked. FIG. 4 shows an error between the output values at this time and the training data and an accuracy rate of the output color name. A mean square error is a mean value of squares of errors between the output values of the neural network and the training data. An accuracy rate of the output color name shows a matching rate of color name corresponding to the unit which outputs the greatest value of the neural network with all 1272 data of the answers obtained in the psychophysical experiment. The accuracy rate 1 means a probability that the color name corresponding to the greatest output of the neural network matches the color name which is answered the most frequently out of 8 time answers in the psychophysical experiment, and the accuracy rate 2 means a probability that the color name corresponding to the greatest output of the neural network matches the color name which is answered anywhere in 8 time replies in the psychophysical experiment.

Further, illumination lights other than three types of illumination lights used in the experiment are verified. This is to verify outputs for unknown data, and it is useful to evaluate performance of the obtained neural network. As the unknown illumination lights, 10 types of Daylight data having color temperatures of 5000K through 20000K are used. FIG. 5 shows spectral distribution of Daylight data. To obtain the accuracy rate of the output result at this time, the above result of the psychophysical experiment are used as a correct answer of the color name of each color chip, and as for the output result of 5000K through 6000K, the output that matches to either of the experimental result of 3000K or 6500K is judged as a correct answer. Similarly, as for the output results of 7000K through 20000K, the output that matches to either of the experimental result of 6500K or 25000K is judged, and in case of the output result of 6500K, the output that matches to the case of 6500K is judged as a correct answer. From FIG. 6, it is understood that a neural network that can output at a high accuracy rate for all illumination light conditions is obtained.

FIG. 7 shows connection weights of the obtained neural network. Here, a solid line shows a plus value, and a broken line shows a minus value. Further, amount of the connection weights is shown by the thickness of the line.

In order to check the effectiveness of the neural network of the present invention, similar experiment is carried out using another neural network. This is to clarify that the neural network of the present invention is a robust model for variation of illumination light compared with another neural network which is not sufficiently adapted to variation of illumination light.

The neural network for comparison is a three-layered feed forward neural network including 6 units in the input layer, 11 units in the hidden layer, and 11 units in the output layer as shown in FIG. 8. Sigmoid function is used for input/output function of each unit of the hidden layer and the output layer.

The input layer is the same as one of the neural network of the present invention. Learning of another neural network having different number of units in the hidden layer is done using the same learning data as a preliminary experiment to decide the number of units of the hidden layer. From the result of the preliminary experiment, the number of units by providing which the mean square error is reduced is selected, and it is decided to use a network having 11 units in the hidden layer. The units in the output layer is the same as the one of the neural network of the present invention.

Connection between the input layer and the hidden layer is full connection, and connection between the hidden layer and the output layer is also full connection.

The same training data set is used as the one used in the above experiment, and the modified moment method of the backpropagation method is used as a learning method as well as the above experiment.

Result of the comparison experiment is shown. FIG. 9 shows a verification result of the training data in the comparison experiment. It can be said a good result is obtained as the verification result of the training data. Here, the connection weight of the obtained neural network is shown in FIG. 10.

FIG. 11 shows a result of verification of variation of unknown illumination light which is done similarly to the above experiment. It is understood that although high accuracy rate is maintained for the illumination light of which chromaticity is close to the illumination light used for the training data, the accuracy rate is decreased when the illumination light of which chromaticity is between the training data and another training data is used. In particular, the accuracy rates of cases from DL5000K through DL6000K are not good.

In the neural network obtained by the comparison experiment, input values are generated by changing (x, y) chromaticity of the test color by every 0.01 for each of illumination lights (3000K, 6500K, and 25000K: three types) and each of luminances (Lum=5, 10, 30, 50, and 75 [cd/m2]: five types), and response of the hidden units is obtained for each luminance of the illumination light from the output value. It is estimated from the responses of the hidden units how the neural network accomplishes categorical perception. As a result, in the verification result of variation of the illumination light in the comparison experiment, it can be estimated the reason why the accuracy rate of color name is low when the illumination light of which chromaticity is far from the illumination light used for the training data (DL 5000K through DL 6000K, etc.) is used as unknown data.

Seeing the output result of the units of the hidden layer of the comparison experiment, there are only two cases in which the output value is changed when the input illumination light is changed, and further, in case of a certain illumination light, the output value varies for each input of the test color, and in cases of other illumination light, the output is fixed. That is, the hidden units apparently seem to respond to the illumination light; however, the reaction is specific to the illumination light of the training data, and does not occur for other illumination light.

This means that, as for the correction of the illumination lights, it is the most efficient learning as the backpropagation method of the neural network to obtain the hidden units which are specialized to three types of illumination lights that are used for the training data, which matches the evaluation result showing that the accuracy rate is low in cases of unknown illumination lights.

Then, input/output responses of the units of the hidden layer are examined in the experiment of the present invention. In the neural network obtained by the experiment of the present invention, input values are generated by changing (x, y) chromaticity of the test color by every 0.01 for each of illumination lights (3000K, 6500K, and 25000K: three types) and each of luminances (Lum=5, 10, 30, 50, and 75 [cd/m2]: five types), and response of the hidden units is obtained for each luminance of the illumination light from the output value. It is estimated from the responses of the hidden units which of internal expression each unit represents for human color vision. As a result, in the input-side hidden layer, the hidden units which perform a linear processing on the input are obtained. Further, in the output-side hidden layer, most of the hidden units change the output values when the input illumination light is changed, and further, change the output values for each input of the test color for all of the illumination lights and show a clear border line so as to divide color space. That is, hidden units which are specialized to the illumination light of the training data do not appear, and it is understood that robust correction can be done for general illumination lights as a whole.

This is supported by the fact that, in the embodiment result of the present invention shown in FIG. 6, the accuracy rate of unknown illumination lights (DL 5000K through DL 6000K, etc.), which is low in the comparison experiment, is high.

In the structure of the neural network according to the present invention, at the input side, the portion corresponding to illumination light components and the portion corresponding to test color components are provided independently, and further the connection weights of them are shared, so that a signal processing in visual system of the input-side hidden layer portion corresponding to illumination light components becomes equivalent to a signal processing in visual system of the input-side hidden layer portion corresponding to test color components, which unites perceptual significances of a group of signals caused by sample light and a group of signals caused by illumination light, and which means correction of irradiation light can be functionally accomplished in higher dimensional perception.

As discussed, it is understood that the neural network of the present invention has obtained a robust perception system mechanism by comparing with the comparison experiment.

Finally, a structure of the categorical color perception system will be explained. FIG. 12 shows a structure related to learning. A neural network for learning 1201 and a memory unit of connection weight data for learning 1202 are included. The neural network for learning 1201 uses the above neural network according to the present invention for learning. The memory unit of connection weight data for learning 1202 is a memory area for storing connection weights obtained by the above neural network of the present invention.

The neural network for learning 1201 includes at least four layers of an input layer, an input-side hidden layer, an output-side hidden layer provided between the input-side hidden layer and an output layer, and the output layer. The input layer includes an input layer portion corresponding to illumination light components 102 for inputting components of illumination light in the experimental environment and an input layer portion corresponding to test color components 101 for inputting components of test color which is reflection from a color sample by the illumination light. The input-side hidden layer includes an input-side hidden layer portion corresponding to illumination light components 104 which is not connected to the input layer portion corresponding to test color components 101 but connected to the input layer portion corresponding to illumination light components 102 and an input-side hidden layer portion corresponding to test color components 103 which is not connected to the input layer portion corresponding to illumination light components 102 but connected to the input layer portion corresponding to test color components 101. The output-side hidden layer is connected to the input-side hidden layer portion corresponding to illumination light components 104 and the input-side hidden layer portion corresponding to test color components 103. The output layer includes units corresponding to categorical colors. There can be at least five layers, though the above example has four layers. An additional layer can be provided between the input layer portion corresponding to illumination light components 102 and the input-side hidden layer portion corresponding to illumination light components 104, and between the input layer portion corresponding to test color components 101 and the input-side hidden layer portion corresponding to test color components 103. In such a case, an additional layer for the illumination light components and an additional layer for the test color components have the same number of units and equal connections. In another way, an additional layer can be provided between the input-side hidden layer and the output-side hidden layer, or between the output-side hidden layer and the output layer.

The memory unit of connection weight data for learning 1202 includes a common connection weight memory area for storing common connection weights shared by structurally corresponding connections among connection weights of connections between the input layer portion corresponding to illumination light components 102 and the input-side hidden layer portion corresponding to illumination light components 104 and connections between the input layer portion corresponding to test color components 101 and the input-side hidden layer portion corresponding to test color components 103. For other connection weights, an exclusive connection weight memory area is provided for storing exclusive connection weights.

FIG. 13 shows a structure related to the judgment. A neural network for judgment 1301 and a memory unit of connection weight data for judgment 1302 are included. The neural network for judgment 1301 uses the above neural network of the present invention for judgment. The memory unit of connection weight data for judgment 1302 is a memory area for duplicating and storing connection weights obtained by the memory unit of connection weight data for learning 1202. Namely, the memory unit of connection weight data for judgment 1302 stores the same connection weights data as the memory unit of connection weight data for learning 1202.

The neural network for judgment 1301 inputs components of ambient light in the judgment environment as illumination light components, inputs components of reflected color from an object to be judged under the judgment environment as test color components, performs a neural network operation process according to the connection weights stored in the memory unit of connection weight data for judgment 1302, and as a processed result, outputs a categorical color which is predicted to be perceived by an observer from the object to be judged under the judgment environment. At this time, the categorical color corresponding to the unit having the greatest output value among multiple units of the output layer is outputted. That is, a categorical color judging unit is provided for comparing the output values from multiple units of the output layer, specifying a categorical color assigned to the unit having the greatest output value, and outputting the categorical color.

The categorical color perception system according to the present invention is a computer, and each element can be implemented by programs. Further, it is also possible to store the program in a storage medium so as to be read by the computer from the storage medium. The computer includes a bus, an operation device connected to the bus, a memory, a storage medium, an inputting device for inputting data, and an outputting device for outputting the data. The neural network for learning and the neural network for judgment can be implemented by programs stored in the storage medium, each program is loaded to the memory from the storage medium through the bus, and the operation device reads codes of the program loaded to the memory and executes processes of the codes in series. Although the neural network for learning and the neural network for judgment are provided separately in the above example, the same neural network can be used when shared. Further, although the memory unit of connection weight data for learning and the memory unit of connection weight data for judgment are provided separately, the same memory unit of connection weight data can be used when shared. The memory unit of connection weight data for learning and the memory unit of connection weight data for judgment are usually provided at the above storage medium or the memory. The categorical color perception system further includes, as shown in FIGS. 12 and 13, an illumination light components inputting unit 1203 for inputting components of the illumination light, a test components inputting unit 1204 for inputting components of the test color, a categorical color inputting unit 1205 for inputting information to specify a categorical color, an ambient light components inputting unit 1303 for inputting components of ambient light of the judgment environment, a reflected color components inputting unit 1304 for inputting components of reflected color from an object to be judged under the judgment environment, and a categorical color outputting unit 1306 for outputting information to specify the categorical color. Further, a connection weight data duplicating unit 1206 for duplicating the connection weight data from the memory unit of connection weight data for learning 1202 to the memory unit of connection weight data for judgment 1302 is also included. In another way, the structure related to the learning of the categorical color perception system shown in FIG. 12 and the structure related to the judgment of the categorical color perception system shown in FIG. 13 can be separate computers, respectively. In such a case, the connection weight data is transferred from the computer of the structure related to the learning to the computer of the structure related to the judgment via a portable storage medium or communication medium. That is, the computer of the structure related to the learning includes a connection weight data outputting unit 1207 for reading the connection weight data from the memory unit of connection weight data for learning 1202 and outputting, and the computer of the structure related to the judgment includes a connection weight data inputting unit 1305 for inputting the connection weight data and storing it in the memory unit of connection weight data for judgment 1302.

An object of the present system is to identify an essential color of the object to be judged, from which influence of each ambient light is eliminated, as a category under various ambient lights. The following explains features of the present system and that the object is accomplished by operation due to the features.
A. Connections between the input layer portion corresponding to illumination light components and the input-side hidden layer portion corresponding to illumination light components, and between the input layer portion corresponding to test color components and the input-side hidden layer portion corresponding to test color components

These connections have a function to develop the components of the light inputted to the input layer to the components of a space of a new coordinate system by the input-side hidden layer. In the example, the components of the input light are three (L cone response value, M cone response value, S cone response value), and the components of the input light in the three-dimensional space are converted to the components in a four-dimensional space of another coordinate system. Among the components of the input light, the L cone response value and the M cone response value show relatively close wavelength distributions; however, it is known that the S cone response value has wavelength distribution far from ones of the L cone response value and the M cone response value. Therefore, it is estimated that a space formed by the components of the input light may have uneven space density according to the spectral region. However, in order to perform correct color perception in all spectral regions according to the object of the present invention, it is desirable to operate in a space with even density. The input-side hidden layer portion corresponding to illumination light components and the input-side hidden layer portion corresponding to test color components are provided to obtain a coordinate system in which the space density is even in all of the spectral regions for the illumination light and the test color. As shown in FIG. 6, it is estimated that good judgmental results are obtained for illumination light of any spectral from DL5000K to DL20000K because of this structure.

Although in the example, the coordinate system is converted from three-dimension to higher dimension, four-dimension by increasing one dimension as the most suitable form, it is expected to obtain the coordinate system in which space density is even in all spectral regions in case of converting the coordinate system to higher dimension or to the same dimension. Namely, the effect of the present invention can be obtained in forms in which the number of units of the input-side hidden layer portion corresponding to illumination light (the same can be said for the number of units of the input-side hidden layer portion corresponding to test color components) is larger by 1, 2 or more than, or the same number as the number of units of the input layer portion corresponding to illumination light components (the same can be said for the number of units of the input layer portion corresponding to test color components).
B. Use of common connection weight by connections that are structurally corresponding to each other between the connection weight between the input layer portion corresponding to illumination light components and the input-side hidden layer portion corresponding to illumination light components and the connection weight between the input layer portion corresponding to test color components and the input-side hidden layer portion corresponding to test color components

By using common connection weight, the illumination light and the test color are converted to components in a space of the same coordinate system. That is, the structurally corresponding units of the same type of the input-side hidden layer portion corresponding to illumination light components and the input-side hidden layer portion corresponding to test color components (for example, “a” of 103 and “e” of 104, or “b” and “f” similarly, in FIG. 1) show the same coordinate axis. In this way, by developing the illumination light and the test color to the space of the same coordinate system, it is easy to obtain the mechanism to eliminate influence of the illumination light.
C. Connection between the input-side hidden layer and the output-side hidden layer In this connection, it is expected to obtain by subtracting the converted illumination light components from the converted test color components of the input-side hidden layer, the essential color components of the color sample by eliminating the influence of the illumination light. In order to do so, it is estimated that canceling operation of the test color components by the same components of the illumination light is carried out. As shown in FIG. 7,
At the unit “b” of the output-side hidden layer, a minus connection with the unit “c” of the input-side hidden layer portion corresponding to test color components is cancelled by a plus connection with the structurally corresponding unit “g” of the input-side hidden layer portion corresponding to illumination light components.
At the unit “d” of the output-side hidden layer, a plus connection with the unit “a” of the input-side hidden layer portion corresponding to test color components is cancelled by a minus connection with the structurally corresponding unit “e” of the input-side hidden layer portion corresponding to illumination light components.
At the unit “e” of the output-side hidden layer, a minus connection with the unit “b” of the input-side hidden layer portion corresponding to test color components is cancelled by a plus connection with the structurally corresponding unit “f” of the input-side hidden layer portion corresponding to illumination light components.
At the unit “f” of the output-side hidden layer, a minus connection with the unit “c” of the input-side hidden layer portion corresponding to test color component is cancelled by a plus connection with the structurally corresponding unit “g” of the input-side hidden layer portion corresponding to illumination light components.
At the unit “g” of the output-side hidden layer, a plus connection with the unit “c” of the input-side hidden layer portion corresponding to test color components is cancelled by a minus connection with the structurally corresponding unit “g” of the input-side hidden layer portion corresponding to illumination light components.

In this way, it is estimated that essential color components can be obtained by eliminating influence from the illumination light in the output-side hidden layer.
D. The output-side hidden layer

It is estimated that the output-side hidden layer accomplishes high-dimensional judgment mechanism for making the color components correspond to the basic categorical color by respectively connecting the input-side hidden layer and the output layer as well as obtaining the essential color components as discussed above. In order to cancel components each other as discussed above, that is, to cancel connections with units of the input-side hidden layer portion corresponding to test color component by connections with units of the input-side hidden layer portion corresponding to illumination light components, the number of units of the output-side hidden layer needs to be at least the number of components, namely, the number of units of the input-side hidden layer portion corresponding to test color components (the same can be said for the number of units of the input-side hidden layer portion corresponding to illumination light components). However, to make correspondence with the above basic categorical color, more numbers of units are necessary, and further, if the number is equal to or less than the number of units of the output layer, the effect of the invention can be obtained. Here, it is the most suitable to provide seven units as the example according to the experiment.

### Embodiment 2

In the present embodiment, a form will be explained, in which the categorical color perception system of the invention is applied to a robot. FIG. 14 shows a structure of a robot to which the categorical color perception system is applied.

The robot includes an ambient light inputting camera unit 1401 for taking in ambient light as an eye of the robot, an ambient light color components sensor unit 1402 for extracting components of the ambient light from an output signal of the ambient light inputting camera unit 1401, an object image taking camera unit 1403 for taking in reflected light of an object to be judged, an object-to-be-judged reflected color components sensor unit 1404 for extracting color components from an output signal of the object image taking camera unit 1403, a categorical color perception system 1405 for inputting the output signal of the ambient light color components sensor unit 1402 and an output signal of the object-to-be-judged reflected color components sensor unit 1404 and judging a categorical color of the object to be judged, a robot controlling unit 1406 for controlling the robot, and a robot driving unit 1407 for inputting control information from the robot controlling unit 1406 and driving an operation device such as a motor.

The following shows the operation. The ambient light inputting camera unit 1401 takes in the ambient light and outputs a receiving light signal of the ambient light as an output signal. The ambient light color components sensor unit 1402 inputs the output signal outputted by the ambient light inputting camera unit 1401 and extracts color components of the ambient light from the output signal.

Further, at the same time, the object image taking camera unit 1403 takes in reflected light of the object to be judged and outputs a receiving light signal of the reflected light of the object to be judged as an output signal. The object-to-be-judged reflected color components sensor unit 1404 inputs the output signal outputted by the object image taking camera unit 1403 and extracts color components of the reflected light from the output signal.

The categorical color perception system 1405 inputs the color components of the ambient light which is the output of the ambient light color components sensor unit 1402 and the color components of the reflected light which is the output of the object-to-be-judged reflected color components sensor unit 1404 and judges a categorical color of the object to be judged as discussed above.

The robot controlling unit 1406 inputs the categorical color which is the output of the categorical color perception system 1405 and generates a control signal for controlling the robot according to the categorical color. The robot driving unit 1407 inputs the control signal which is the output of the robot controlling unit 1406 and drives the operation device such as a motor.

Since this robot uses the categorical color perception system 1405 according to the present invention, it is possible to do color discrimination similarly to human eyes in various environments. For example, even when the ambient light is irregular, it is possible to track or grasp a moving body of the indicated categorical color.

### Embodiment 3

In the present embodiment, a form will be explained, in which the categorical color perception system of the present invention is applied to a surveillance camera system. FIG. 15 shows a structure of a surveillance camera system to which the categorical color perception system is applied.

The surveillance camera system includes, in addition to the ambient light inputting camera unit 1401, the ambient light color components sensor unit 1402, the object image taking camera unit 1403, the object-to-be-judged reflected color components sensor unit 1404, and the categorical color perception system 1405 which are the same as discussed above, a surveillance camera controlling unit 1501 for controlling the surveillance camera, an image recording unit 1502 for recording the image taken by the object image taking camera unit 1403, an alarm generating unit 1503 for generating an alarm according to a control signal outputted by the surveillance camera controlling unit 1501, and an information recording unit 1504 for recording recognition result outputted by the surveillance camera controlling unit 1501.

The following shows the operation. The ambient light inputting camera unit 1401 takes in the ambient light and outputs a receiving light signal of the ambient light as an output signal. The ambient light color components sensor unit 1402 inputs the output signal outputted by the ambient light inputting camera unit 1401 and extracts color components of the ambient light from the output signal.

Further, at the same time, the object image taking camera unit 1403 takes in reflected light of the object to be judged and outputs a receiving light signal of the reflected light of the object to be judged as an output signal. The object-to-be-judged reflected color components sensor unit 1404 inputs the output signal outputted by the object image taking camera unit 1403 and extracts color components of the reflected light from the output signal.

The categorical color perception system 1405 inputs the color components of the ambient light which is the output of the ambient light color components sensor unit 1402 and the color components of the reflected light which is the output of the object-to-be-judged reflected color components sensor unit 1404 and judges a categorical color of the object to be judged as discussed above.

The surveillance camera controlling unit 1501 inputs the categorical color which is the output of the categorical color perception system 1405 and generates a control signal for controlling the surveillance camera according to the categorical color. For example, when an alarm instruction is outputted as the control signal, the alarm generating unit 1503 generates the alarm according to the alarm instruction. Further, when recognition result is outputted by the control signal, the information recording unit 1504 records the recognition result.

Since this surveillance camera system uses the categorical color perception system 1405 according to the present invention, it is possible to do color discrimination similarly to human eyes in various environments. For example, even when the ambient light is irregular, it is possible to generate an alarm or record recognition result when a moving body of the indicated categorical color (for example, a person wearing red clothes) is recognized.

### Embodiment 4

In the present embodiment, a form will be explained, in which the categorical color perception system of the present invention is applied to a color coordination simulation system. FIG. 16 shows a structure of the first example of a color coordination simulation system to which the categorical color perception system is applied.

The color coordination simulation system includes, in addition to the object image taking camera unit 1403, the object-to-be-judged reflected color components sensor unit 1404, and the categorical color perception system 1405 which are the same as discussed above, a color coordination simulation controlling unit 1603, an ambient light color components generating unit 1602 for generating ambient light color components from ambient light information inputted by the color coordination simulation controlling unit 1603, an inputting unit 1601 for inputting information specifying the ambient light, and a displaying unit 1604 for displaying simulation result, etc.

The following shows the operation. The inputting unit 1601 inputs specifying information of ambient light. The ambient light color components generating unit 1602 converts the specifying information of the ambient light to color components of the ambient light.

Further, at the same time, the object image taking camera unit 1403 takes in reflected light of the object to be judged and outputs a receiving light signal of the reflected light of the object to be judged as an output signal. The object-to-be-judged reflected color components sensor unit 1404 inputs the output signal outputted by the object image taking camera unit 1403 and extracts color components of the reflected light from the output signal.

The categorical color perception system 1405 inputs the color components of the ambient light corresponding to the ambient light which is the output of the ambient light color components generating unit 1602 and the color components of the reflected light which is the output of the object-to-be-judged reflected color components sensor unit 1404 and judges a categorical color of the object to be judged as discussed above.

By this, with assuming the specified ambient light, it is possible to simulate which categorical color is judged by human visual observation from the color information of the object taken by the object image taking camera unit 1403.

### Embodiment 5

In the present embodiment, a form will be explained, in which reflected light of the object is further specified. FIG. 17 shows a structure of the second example of the color coordination simulation system to which the categorical color perception system is applied.

The inputting unit 1601 inputs information specifying ambient light and information specifying reflected light of the object to be judged. The ambient light color components generating unit 1602 converts the specifying information of the ambient light to color components of the ambient light.

Further, at the same time, the object-to-be-judged reflected color components generating unit 1701 converts the specifying information of the reflected light of the object to be judged to color components of the reflected light.

The categorical color perception system 1405 inputs the color components of the ambient light which is the output of the ambient light color components generating unit 1602 and the color components of the reflected light which is the output of the object-to-be-judged reflected color components sensor unit 1404 and judges a categorical color of the object to be judged as discussed above.

By this, with assuming the indicated ambient light and the reflected light of the object to be judged, it is possible to simulate which categorical color is judged by human visual observation of the object.

### BRIEF EXPLANATION OF THE DRAWINGS

FIG. 1 shows a structure of a neural network related to the present invention.

FIG. 2 shows chromaticity of illumination light used for learning of the neural network.

FIG. 3 shows spectral distribution of the illumination light used for learning by the neural network.

FIG. 4 shows verified result of training data in an experiment of the present invention.

FIG. 5 shows spectral distribution of Daylight data.

FIG. 6 shows verified result of unknown illumination light in the experiment of the present invention.

FIG. 7 shows connection weights of the neural network in the experiment of the present invention.

FIG. 8 shows a structure of a neural network related to a comparison experiment.

FIG. 9 shows verified result of training data in the comparison experiment.

FIG. 10 shows connection weights of the neural network in the comparison experiment.

FIG. 11 shows verified result of unknown illumination light in the comparison experiment.

FIG. 12 shows a structure related to learning in a categorical color perception system.

FIG. 13 shows a structure related to judgment in the categorical color perception system.

FIG. 14 shows a structure of a robot to which the categorical color perception system is applied.

FIG. 15 shows a structure of a surveillance camera system to which the categorical color perception system is applied.

FIG. 16 shows a structure of the first example of a color coordination simulation system to which the categorical color perception system is applied.

FIG. 17 shows a structure of the second example of the color coordination simulation system to which the categorical color perception system is applied.

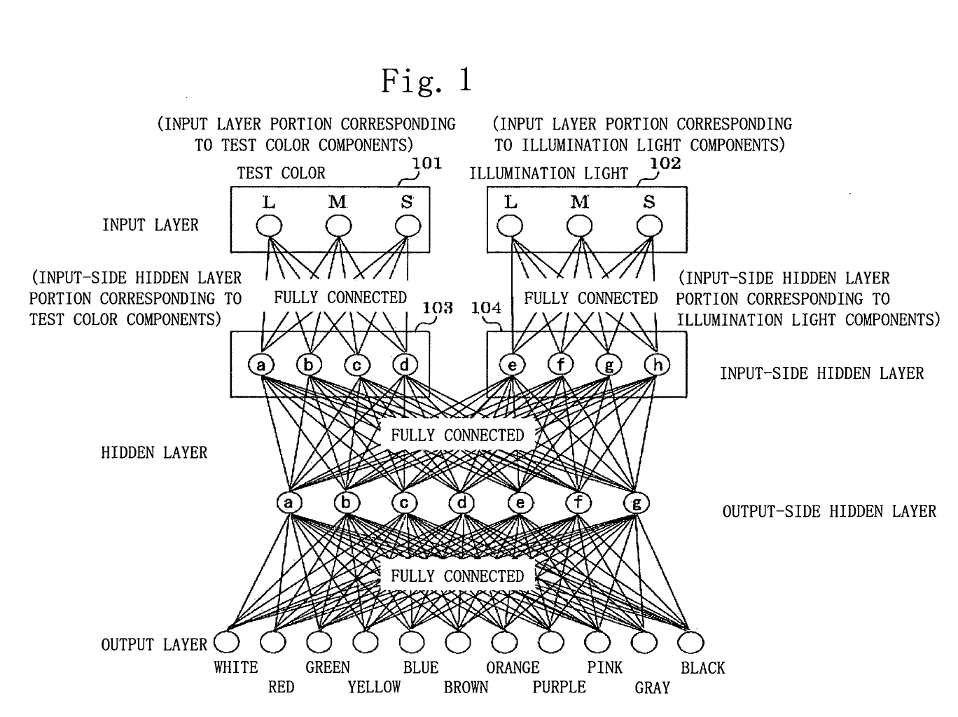

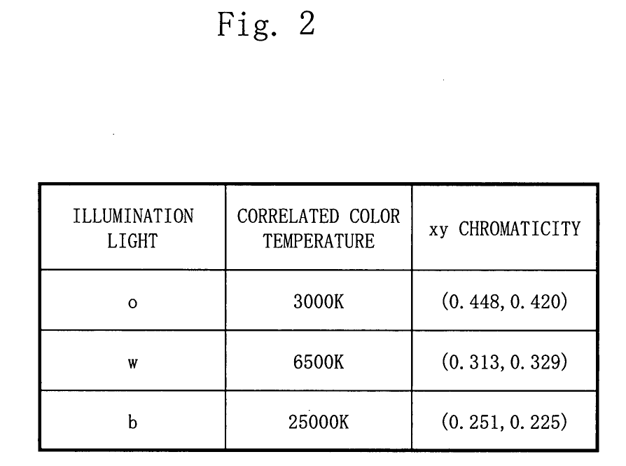

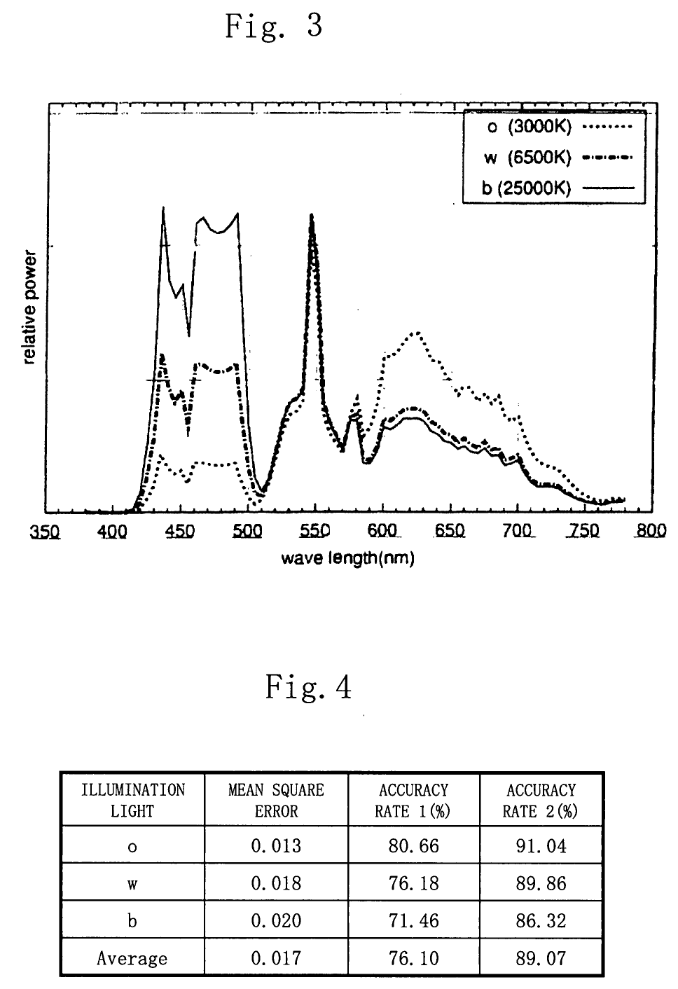

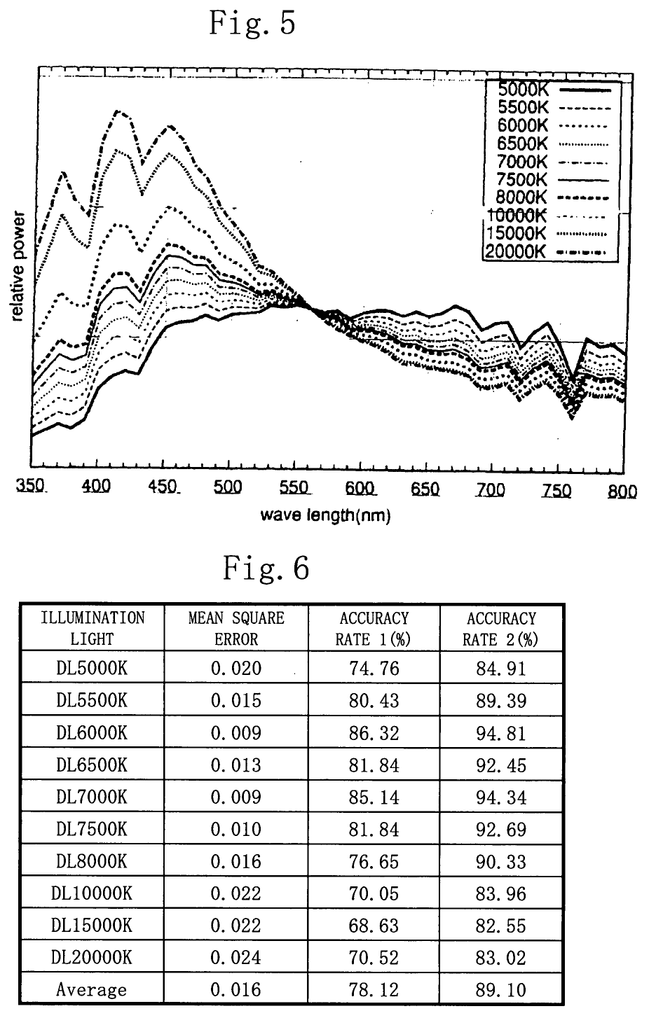

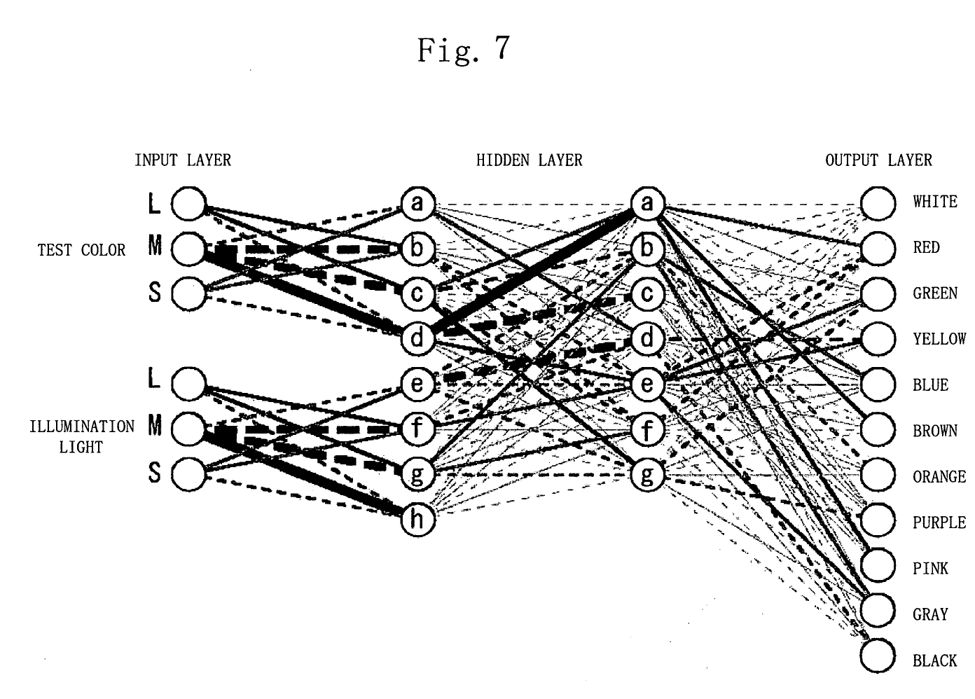

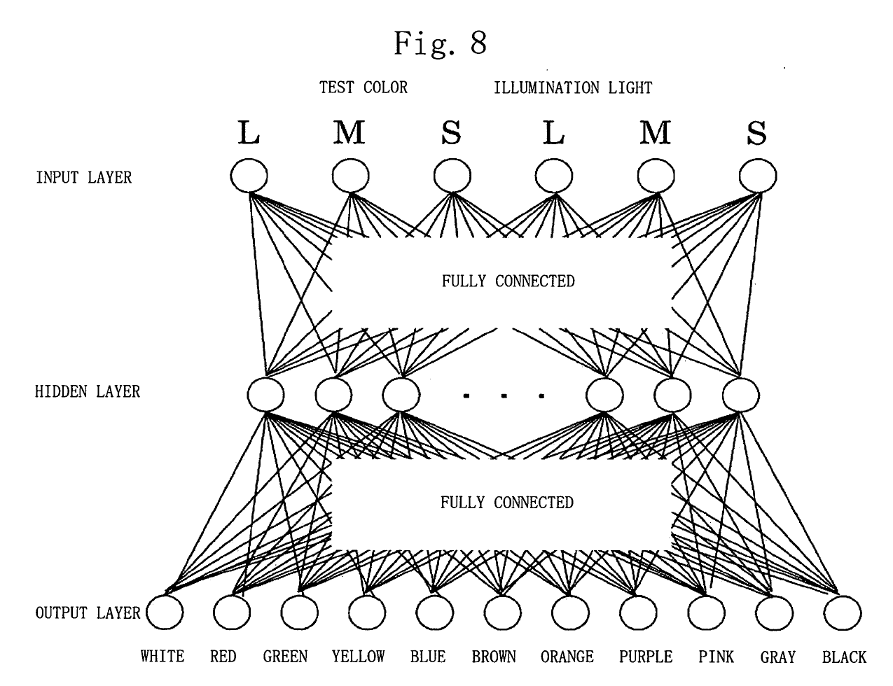

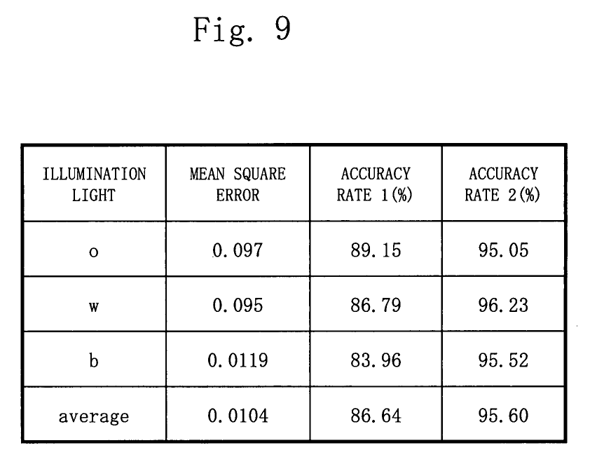

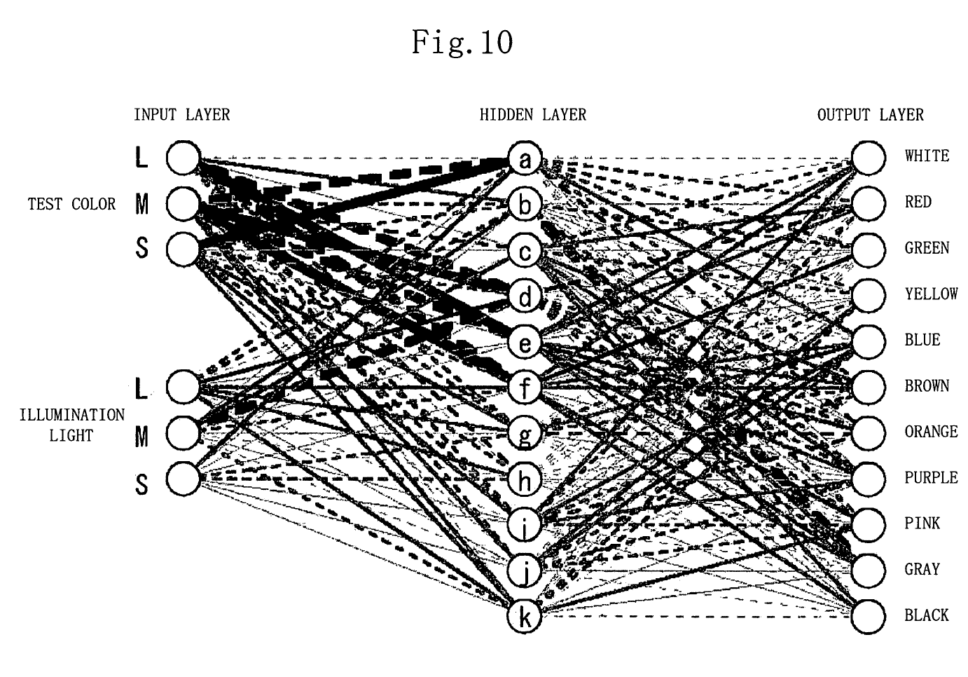

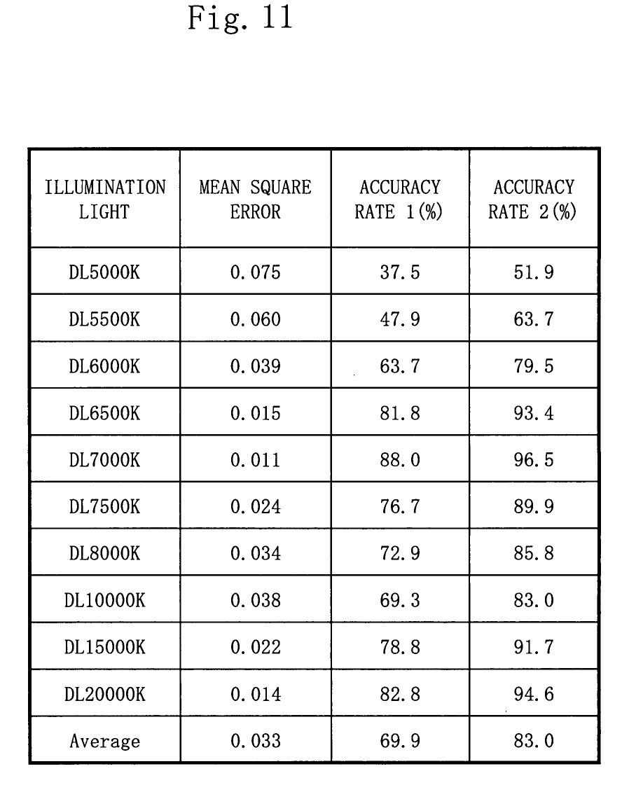

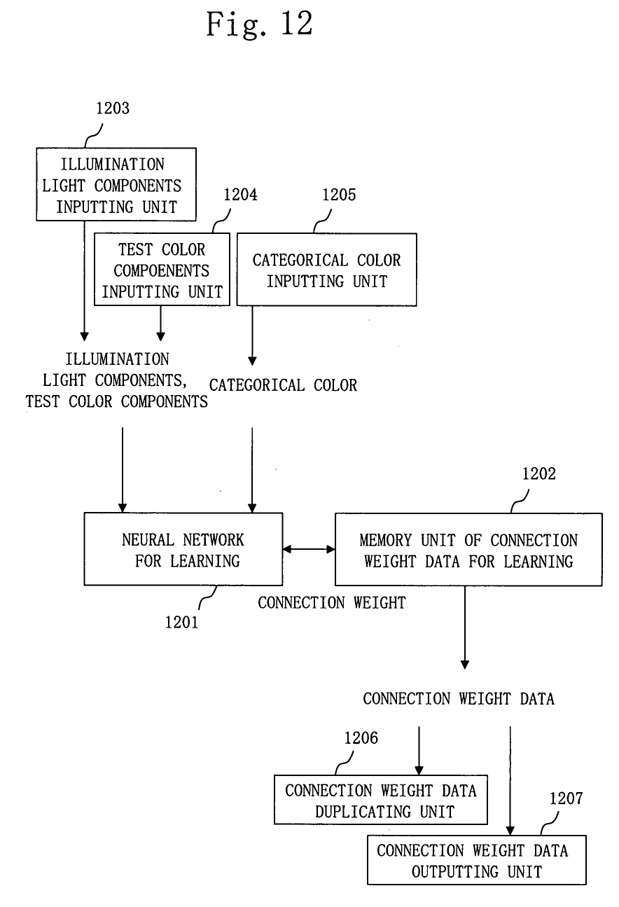

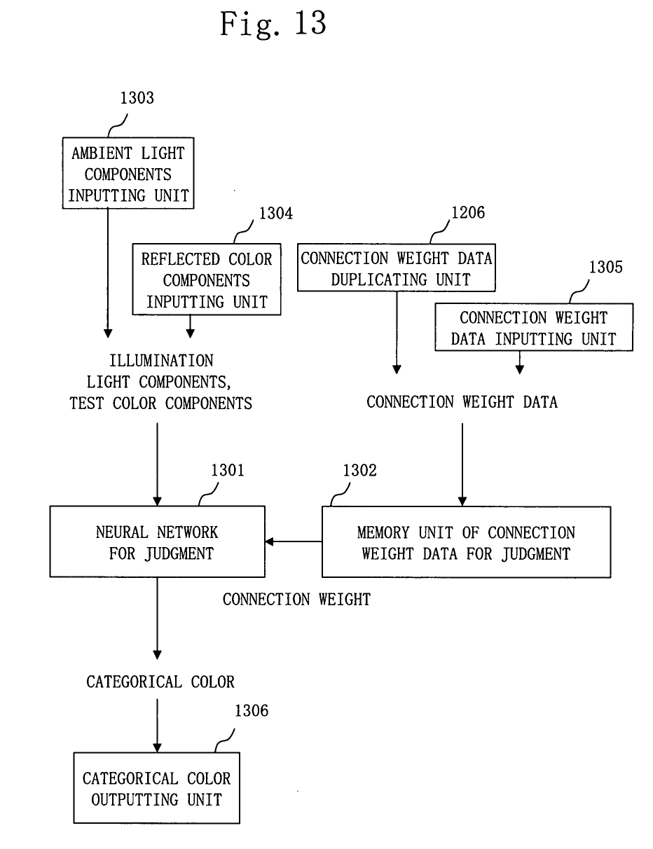

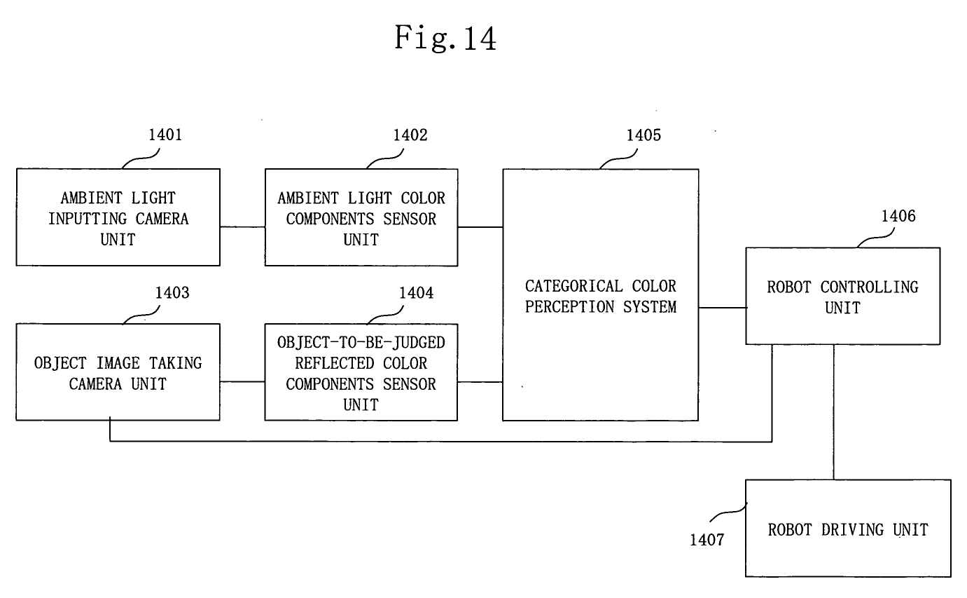

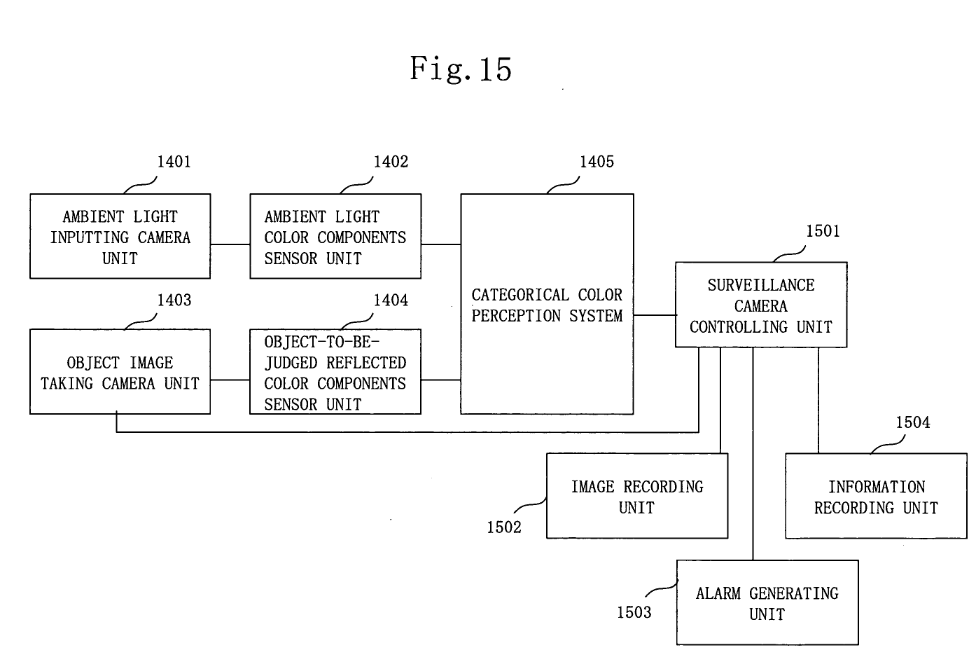

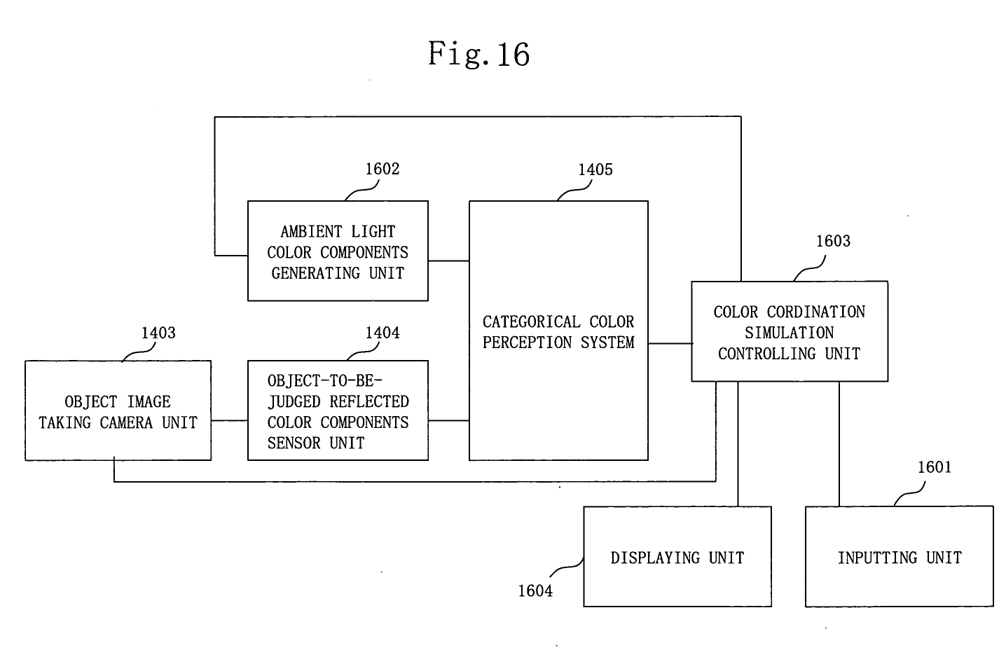

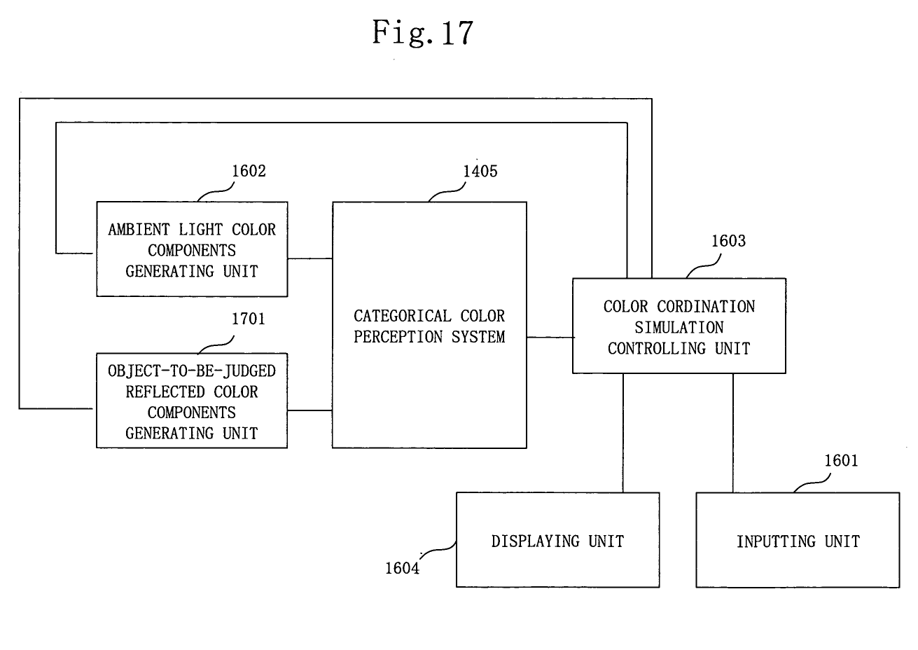

### EXPLANATION OF SIGNS

101: an input layer portion corresponding to test color components; 102: an input layer portion corresponding to illumination light components; 103: an input-side hidden layer portion corresponding to test color components; 104: an input-side hidden layer portion corresponding to illumination light components; 1201: a neural network for learning; 1202: memory unit of connection weight data for learning; 1203: an illumination light components inputting unit; 1204: a test color components inputting unit; 1205: a categorical color inputting unit; 1206: a connection weight data duplicating unit; 1207: a connection weight data outputting unit; 1301: a neural network for judgment; 1302: a memory unit of connection weight data for judgment; 1303: an ambient light components inputting unit; 1304: a reflected color components inputting unit; 1305: a connection weight data inputting unit; 1306: a categorical color outputting unit; 1401: an ambient light inputting camera unit; 1402: an ambient light color components sensor unit; 1403: an object image taking camera unit; 1404: an object-to-be-judged reflected color components sensor unit; 1405: a categorical color perception system; 1406: a robot controlling unit; 1407: a robot driving unit; 1501: a surveillance camera controlling unit; 1502: an image recording unit; 1503: an alarm generating unit; 1504: an information recording unit; 1601: an inputting unit; 1602: an ambient light color components generating unit; 1603: a color coordination simulation controlling unit; 1604: a displaying unit; and 1701: an object-to-be-judged reflected color components generating unit.

1-11. (canceled)

12. A categorical color perception system inputting components of ambient light under a judgment environment and components of a reflected color by an object to be judged under the judgment environment and outputting a categorical color that is a categorized color name which is predicted to be perceived by an observer with the object to be judged under the judgment environment, the categorical color perception system comprising:
(1) a connection weights for judgment data memory unit storing connection weights obtained by learning in a neural network for learning,
wherein the neural network for learning has at least four layers of an input layer, an input-side hidden layer, an output-side hidden layer provided between the input-side hidden layer and an output layer, and the output layer,
wherein the input layer comprises an input layer portion corresponding to illumination light components for inputting components of illumination light under a experimental environment and an input layer portion corresponding to test color components for inputting components of a test color that is reflection of the illumination light by a color sample,
wherein the input layer portion corresponding to illumination light components and the input layer portion corresponding to test color components comprise a same number of units for inputting color components in a same method,
wherein the input-side hidden layer comprises an input-side hidden layer portion corresponding to illumination light components which is not connected to the input layer portion corresponding to test color components but connected to the input layer portion corresponding to illumination light components and an input-side hidden layer portion corresponding to test color components which is not connected to the input layer portion corresponding to illumination light components but connected to the input layer portion corresponding to test color components,
wherein the input-side hidden layer portion corresponding to illumination light components and the input-side hidden layer portion corresponding to test color components comprise a same number of units,
wherein the output-side hidden layer is connected to the input-side hidden layer portion corresponding to illumination light components and the input-side hidden layer portion corresponding to test color components,
wherein the output layer corresponds to categorical colors;
wherein the neural network for learning uses connection weights shared by structurally corresponding connections for connection weights with respect to connections between the input layer portion corresponding to illumination light components and the input-side hidden layer portion corresponding to illumination light components and connection weights with respect to connections between the input layer portion corresponding to test color components and the input-side hidden layer portion corresponding to test color components; and
wherein the connection weights stored are obtained with a backpropagation method in which the neural network for learning inputs components of illumination light color for learning and components of test color for learning and output a categorical color for learning perceived by an examinee from the color sample under the illumination light; and
(2) a neural network for judgment having a same structure with the neural network for learning,
wherein the neural network for judgment inputs the components of the ambient light of the judgment environment as the components of the illumination light color and inputs the components of the reflected color by the object to be judged under the judgment environment as the components of the test color;
wherein the neural network for judgment uses connection weights shared by structurally corresponding connections for connection weights with respect to connections between the input layer portion corresponding to illumination light components and the input-side hidden layer portion corresponding to illumination light components and connection weights with respect to connections between the input layer portion corresponding to test color components and the input-side hidden layer portion corresponding to test color components; and
wherein the neural network for judgment carries out a neural network operation process according to the connection weights stored in the connection weights for judgment data memory unit, and outputs the categorical color predicted to be perceived by the observer with the object to be judged under the judgment environment as a processed result.

13. The categorical color perception system of claim 12, wherein a number of units of the input-side hidden layer portion corresponding to illumination light components and a number of units of the input-side hidden layer portion corresponding to test color components are at least a number of units of the input layer portion corresponding to illumination light components and a number of units of the input layer portion corresponding to test color components.

14. The categorical color perception system of claim 13, wherein the number of units of the input layer portion corresponding to illumination light components and the number of units of the input layer portion corresponding to test color components are 3, and the number of units of the input-side hidden layer portion corresponding to illumination light components and the number of units of the input-side hidden layer portion corresponding to test color components are 4.

15. The categorical color perception system of claim 12, wherein a number of units of the output-side hidden layer is at least a number of units of the input-side hidden layer portion corresponding to illumination light components and a number of units of the input-side hidden layer portion corresponding to test color components.

16. The categorical color perception system of claim 15, wherein the number of units of the output-side hidden layer is not greater than a number of units of the output layer.

17. The categorical color perception system of claim 16, wherein the number of units of the input-side hidden layer portion corresponding to illumination light components and the number of units of the input-side hidden layer portion corresponding to test color components are 4, the number of units of the output-side hidden layer is 7, and the number of units of the output layer is 11.

18. A robot comprising:
(1) an ambient light inputting camera unit for taking ambient light in and outputting a receiving light signal of the ambient light as a first output signal;
(2) an ambient light color components sensor unit for inputting the first output signal and extracting color components of the ambient light from the first output signal;
(3) an object image taking camera unit for taking in reflected light of an object to be judged and outputting a receiving light signal of the reflected light of the object to be judged as a second output signal;
(4) an object-to-be-judged reflected color components sensor unit for inputting the second output signal and extracting color components of the reflected light from the second output signal;
(5) the categorical color perception system of claim 12 for inputting the color components of the ambient light and the color components of the reflected light and judging a categorical color of the object to be judged according to the color components of the ambient light and the color components of the reflected light;
(6) a robot controlling unit for inputting the categorical color and generating a control signal controlling the robot based on the categorical color; and
(7) a robot driving unit for inputting the control signal and driving an operation device according to the control signal.

19. A surveillance camera system comprising:
(1) an ambient light inputting camera unit for taking ambient light in and outputting a receiving light signal of the ambient light as a first output signal;
(2) an ambient light color components sensor unit for inputting the first output signal and extracting color components of the ambient light from the first output signal;
(3) an object image taking camera unit for taking in reflected light of an object to be judged and outputting a receiving light signal of the reflected light of the object to be judged as a second output signal;
(4) an object-to-be-judged reflected color components sensor unit for inputting the second output signal and extracting color components of the reflected light from the second output signal;
(5) the categorical color perception system of claim 12 for inputting the color components of the ambient light and the color components of the reflected light and judging a categorical color of the object to be judged according to the color components of the ambient light and the color components of the reflected light; and
(6) a surveillance camera controlling unit for inputting the categorical color and generating a control signal controlling the surveillance camera system based on the categorical color.

20. A color coordination simulation system comprising:
(1) an inputting unit for inputting specified information of ambient light;
(2) an ambient light color components generating unit for converting the specified information of the ambient light to color components of the ambient light;
(3) an object image taking camera unit for taking in reflected light of an object to be judged and outputting a receiving light signal of the reflected light of the object to be judged as an output signal;
(4) an object-to-be-judged reflected color components sensor unit for inputting the output signal and extracting color components of the reflected light from the output signal; and
(5) the categorical color perception system of claim 12 for inputting the color components of the ambient light and the color components of the reflected light and judging a categorical color of the object to be judged according to the color components of the ambient light and the color components of the reflected light.

21. A color coordination simulation system comprising:
(1) an inputting unit for inputting specified information of ambient light and specified information of reflected light of an object to be judged;
(2) an ambient light color components generating unit for converting the specified information of the ambient light to color components of the ambient light;
(3) an object-to-be-judged reflected color components generating unit for converting the specified information of the reflected light of the object to be judged to color components of the reflected light; and
(4) the categorical color perception system of claim 12 for inputting the color components of the ambient light and the color components of the reflected light and judging a categorical color of the object to be judged according to the color components of the ambient light and the color components of the reflected light.
